(19) United States
(12) Patent Application Publication
(10) Pub. No.: US 2008/0106971 A1
(43) Pub. Date: May 8, 2008

(54) Method of subsalt velocity analysis by combining wave equation based redatuming and kirchhoff based migration velocity analysis

(76) Inventors: Bin Wang, Katy, TX (US); Francois Audebert, Houston, TX (US)

Correspondence Address: David M. Ostfeld;Adams and Reese, LLP, 4400 One Houston Center, 1221 McKinney Street, Houston, TX, 77010, US

(21) Appl. No.: 11/879,926

(22) Filed: Jul. 19, 2007

Related U.S. Application Data
(60) Provisional application No. 60/831,887, filed on Jul. 19, 2006.

(51) Int. Cl. G01V 1/28; G01V 1/38

(52) U.S. Cl. 367/21

(57) ABSTRACT

A low-cost general method to perform subsalt velocity analysis is provided. For instances where sediment velocity structure is relatively simple, the method includes a single one-time redatuming to the base of salt, using existing prestack wave equation tools. For instances where the sediment velocity structure has a variable topography, the method includes multi-step redatuming to the base of salt. The method is designed to completely remove the salt-sediment overburden effects, and redatum the surface seismic data to a flat arbitrary subsalt datum, removing the complexity of the wavefield caused by the salt bodies. Once having obtained a simplified wavefield by stripping off the effects of the complex overburden, less expensive Kirchhoff imaging algorithms are employed for performing subsalt velocity model building.

### CROSS-REFERENCE TO RELATED APPLICATIONS

This application is a non-provisional utility application which claims benefit of U.S. Provisional Patent Application Ser. No. 60/831,887 filed Jul. 19, 2006, entitled “Subsalt Velocity Analysis By Combining Wave Equation Based Redatuming And Kirchhoff Based Migration Velocity Analysis” which is incorporated herein by reference.

### BACKGROUND OF THE INVENTION

1. Field of the Invention

The present invention generally relates to the field of underwater seismic wave measurement. More particularly, the present invention relates to a method of subsalt velocity analysis of seismic waves.

2. Prior Art

The following are prior publications dealing with underwater seismic waves:
Berryhill, J. R., 1979, Wave Equation Datuming: Geophysics, 44, 1329-1344.
Berryhill, J. R., 1984, Wave Equation Datuming Before Stack: Geophysics, 49, 2064-2067.
Bevc, D., 1997, Imaging Complex Structures with Semirecursive Kirchhoff Migration: Geophysics 62, 577-588.
Bevc, D., and Popovici, A. M., 1997, Subsalt Imaging with Semirecursive Kirchhoff Migration: 67^{th} Annual International Meeting, Society of Exploration Geophysicists, Expanded Abstracts, 1090-1091.
Bevc, D., and Popovici, A. M., 1998, Three Dimensional Subsalt Semirecursive Kirchhoff Migration: 60^{th} Annual International Meeting, European Association of Geoscientists & Engineers, Expanded Abstracts, Leipsiz, Germany.
Luo, Y., and Schuster, J., 2004, Bottom up Target-Oriented Reverse-Time Datuming: CPS/SEG International Geophysical Conference, Expanded Abstracts, 482-485.
Wang, B., Dirks V., Guillaume, P., Audebert, F., and Epili, D., 2006, A 3D Subsalt Tomography Based on Wave-Equation Migration-Perturbation Scans: Geophysics, Vol. 71, No. 2, E1-E6.
Wang, B., Qin, F., Dirks V., Guillaume, P., Audebert, F., and Epili, D., 2005, 3D Finite Angle Tomography based on Focusing Analysis, 75^{th} Annual International Meeting, SEG, Expanded Abstracts, 2546-2549.
Wang, B., Qin, F., Audebert, F., and Dirks, V. 2005, A Fast and Low Cost Alternative to Subsalt Wave Equation Migration Perturbation Scans, 75^{th} Annual International Meeting, SEG, Expanded Abstracts, 2257-2260.

### DESCRIPTION OF THE RELATED ART

For typical offshore Gulf of Mexico (“GOM”) seismic data sets, the complexity of the surface seismic wavefield is due primarily to the multi-pathing and illumination effects caused by seismic wave propagation through salt bodies. By using wave equation based migration algorithms, the wave propagation effects are modeled more adequately and a better chance is given of unraveling the earth propagation effects induced by the complex salt-sediment overburdens.

Wavefield redatuming has been studied and described previously, such as Berryhill (1979 and 1984), Bevc (1997), Bevc and Popovici (1997 and 1998), and Luo and Schuster (2004). However, an effective scalable algorithm has not previously been described for performing a source-receiver (“SR”), wave equation based redatuming that may be used effectively for subsalt velocity model building.

Due to the geometrical complexity of the typical GOM velocity models, with embedded salt bodies of any shapes, wave equation migration is used preferentially over Kirchhoff methods for subsalt velocity model building. This preference is based on the ability of wave-equation based migrations to overcome the need for tracing complex ray paths through the salt bodies and for a better handling of multi-path arrivals via wavefield reconstruction.

Subsalt velocity analysis uses prestack wave equation migration scans that are created from perturbed velocity models. This is an accurate method, but because it requires multiple runs of prestack wave equation migration, it is also expensive.

Attempts have been made to use wave equation based migration scan techniques for subsalt velocity updating (Wang et al., 2006). A migration scan is a set of PreSDM stack images that are produced from a set of locally scaled velocity models. However, the cost of generating such migration scans is still very high. The cost of producing a set of scans is essentially linear with respect to the number of models used and can become prohibitively high, when a large scan range is needed.

Two low cost alternatives have been created to attempt to reduce the increased costs of wave equation based migration scan techniques, each of them being applicable to different subsalt situations.

The first alternative (Wang et al.: 2005) makes use of subsalt Common Focusing Error (“CFE”) panels. In that approach, the seismic wavefield is downward continued only once, and zero time as well as non-zero time imaging conditions are applied after each extrapolation step. A pick field is produced by interpreting the best-focused image throughout the set of generated CFE panels. The pick field of focusing errors are received and interpreted by a 3D depth tomography application to update the subsalt velocity field. This alternative, based on focusing analysis, is applicable when the subsalt sediments have relatively simple structure and when a significant angular aperture is still available. However this demigration and remigration approach is more appropriate for deep subsalt areas with subsalt folded structures, such as the Alaminous Canyon, Gulf of Mexico.

The second alternative (Wang et al: 2005), uses the current “vbest” velocity model to produce a single PreSDM stacked subsalt image. The stacked subsalt image is then demigrated to the base of salt to produce demigrated zero-offset data in the time domain. One performs a set of poststack wave equation migration “scans” through variations of the “best” velocity model using the demigrated zero offset data as the input. The interpretation of the best scans leads to the construction of an updated velocity model. This alternative, based on poststack migration scans, provides information such as whether the structure (anticline or syncline) is under or over migrated and whether the structure makes good geological sense.

These two aforementioned alternatives are complimentary; however, they remain two separate methods.

Therefore, there is need for a more general method to perform subsalt velocity analysis, which reduces the computation costs associated with current methods. Various embodiments of a method are offered here which meet these needs.

### SUMMARY OF THE INVENTION

A low-cost general method to perform subsalt velocity analysis is provided. For instances where sediment velocity structure is relatively simple, the method includes a single one-time redatuming to the base of salt (“BOS”), using existing prestack wave equation tools. The method is designed to completely remove the salt-sediment overburden effects, and redatum the surface seismic data to a flat arbitrary subsalt datum. By redatuming, the method removes the complexity of the wavefield caused by the salt bodies. Once having obtained a simplified wavefield by stripping off the effects of the complex overburden, less expensive Kirchhoff imaging algorithms are employed for performing subsalt velocity model building.

### BRIEF DESCRIPTION OF THE DRAWINGS

For a further understanding of the nature and objects of the present invention, reference should be had to the following drawings in which like parts are given like reference numbers and wherein (It is to be noted, however, that the appended drawings illustrate only selected embodiments of the invention and are therefore not to be considered limiting of scope, for the inventions may admit to other equally effective embodiments and applications):

FIG. 1 is a schematic diagram showing the downward continuation of the receiver wavefield from the surface to the BOS datum;

FIG. 2 is a schematic diagram showing the BOS topography and the flat datum surfaces at Zmin and Zmax;

FIG. 3 is a schematic diagram showing the velocity model as seen at the new datum, after redatuming in two steps using two velocity models. The new acquisition at the Zmin datum sees only sediment velocity below Zmin;

FIG. 4A-4C shows CMP gathers at the surface on left as face the paper and gather after redatuming on right;

FIG. 5 shows comparison of subsalt migration images (A) Kirchhoff migration of redatumed date, (B) Kirchhoff migration of surface data; (C) wave equation migration of surface data.

### DETAILED DESCRIPTION OF THE PREFERRED EMBODIMENT

The preferred embodiment of the invention implements a method that is fully scalable, and is accurate for SR redatuming. Work is done with a single shot record at a time.

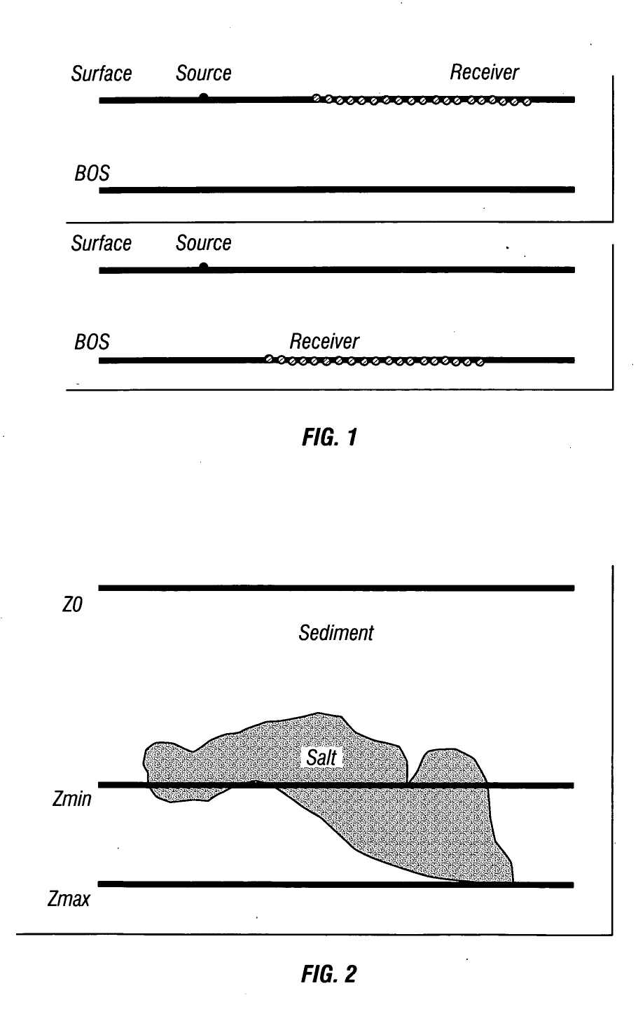

FIG. 1 presents the preferred embodiment of the invention as applied to redatuming the seismic data from the surface to a flat subsurface BOS datum. First the receiver wavefield is downward continued for each shot record, from the surface to the BOS datum. After finishing the downward continuation of the receiver wavefield from the surface to the BOS for all the shot records, the data are sorted to common receiver gathers.

Next, for each common receiver gather, the receiver is located at the BOS datum, while the shots remain located at the surface. The receiver wavefield is again downward continued for each shot record, but now directed from the surface to the receiver. After finishing the downward continuation of the receiver wavefield from the surface to the BOS for all the shot records, the data are sorted to common receiver gathers, although the data obtained from this step are now treated as equivalent to a “new” shot record: one downward continues the “old” source wavefield (that is now a “new” receiver wavefield), from the surface to the BOS datum.

With this procedure, SR redatuming is essentially achieved with one single large extrapolation step in depth, as opposed to the many small steps used in SR migration.

FIG. 2 presents the implementation of the preferred embodiment when the BOS interface may have variable topography. To redatum the wavefield to a flat datum surface, while at the same time removing the effects of the salt bodies, the following operations are performed:

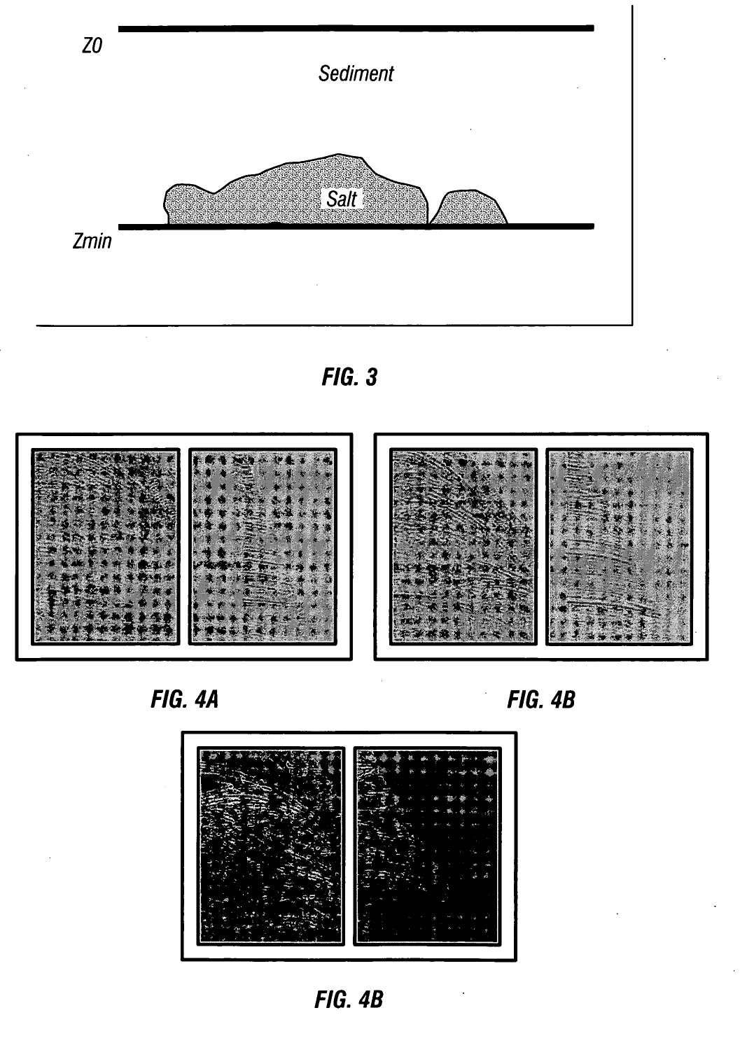

Two flat horizontal surfaces, Zmin and Zmax, with Zmin at the minimum depth of the BOS topography, and Zmax at the maximum depth of the BOS topography are defined. Z0 is the surface (FIGS. 2 and 3). Two velocity models are used: one with the original salt bodies in place, the second one with a replacement of the salt velocity with the sediment velocity (or a fixed constant velocity) within the salt bodies, between Zmin and Zmax.

Next, each step of downward continuation from the surface to the Zmin datum will be split into two substeps: in a first substep, the original model is used, with all the salt bodies, to downward continue the “receiver” wavefield from the surface to the Zmax datum. In the second substep, the second model is used, with the replacement by the sediment velocity, to upward continue the “receiver” wavefield from the Zmax datum to the Zmin datum.

With the above described redatuming method, the wavefield at the Zmin datum is obtained, as if the velocity in the salt bodies between datum Zmin and Zmax had been effectively and legitimately replaced with the sediment velocity (or a constant velocity), as shown by FIG. 3.

At this stage of the redatuming process, there is no need to know precisely the subsalt velocity. However, the geometry of the salt bodies and the salt velocity must be accurate in the first model, and the replacement velocity in the salt bodies, in the second model, should be left untouched in the subsequent iterations of the velocity model building. This datuming plus layer replacement simplifies the wavefield reconstituted at the Zmin datum.

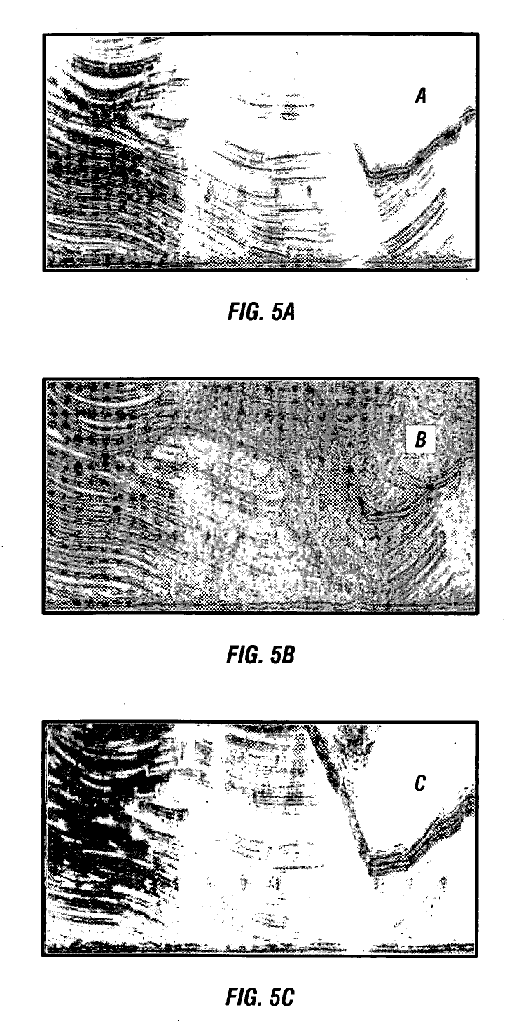

After redatuming a much simplified wavefield, the use of less expensive Kirchhoff migration algorithms is now warranted. This renders velocity analysis very practical and effective in updating the subsalt half-space of the velocity model. See FIGS. 4 and 5.

With current “narrow” azimuth 3D marine acquition, there is a “data explosion” problem in the intermediate step of redatuming. Because significant migration aperture in both x and y directions need to be added, during the intermediate redatuming step, the data are allowed to expand toward wider azimuths. Therefore the intermediate data volume could be 10 times larger than the size of the original input data, thus the term “data explosion”.

However, since the method described herein is scalable, the intermediate data should be deleted on the fly to save disk space.

Furthermore, the final redatumed data could be even smaller in size for the following reasons. First, after redatuming, sources and receivers are moved closer to the subsalt target, thereby reducing the effective offset in both the inline and cross-line directions. Second, after redatuming, the record length is reduced and less time samples are needed. Third, due to attenuation effects, the required range of signal bandwidth is reduced, allowing for a larger sample interval to be used.

For future wide azimuth marine surveys, one may now foresee a tremendous potential for wave equation based redatuming techniques to provide a large uplift in quality for subsalt imaging and take advantage of the natural richness of azimuth information.

I claim:

1. A method for subsalt velocity analysis of a flat subsurface base of salt by combining wave equation based redatuming and Kirchhoff based migration velocity analysis, comprising the steps of: the receiver wavefield being continued downward for all shot records, from the surface to the base of salt datum; sorting the data to common receiver gathers; locating each common receiver gather at the base of salt datum with the shots remaining located at the surface; a second receiver wavefield being continued downward for each shot record, directed from the surface to the receiver; sorting the data for the second wavefield to common receiver gathers; treating the data obtained therefrom as equivalent to a new shot record; and applying Kirchhoff migration algorithms to such data.

2. A method for subsalt velocity analysis of a base of salt having a variable topography by combining wave equation based redatuming and Kirchhoff based migration velocity analysis, comprising the steps of: defining two flat horizontal surfaces, Zmin and Zmax, with Zmin at the minimum depth of the base of salt topography, and Zmax at the maximum depth of the base of salt topography; using two velocity models, one with the original salt bodies in place, the second one with a replacement of the salt velocity with the sediment velocity within the salt bodies between Zmin and Zmax; splitting each step of downward continuation from the surface to the Zmin datum into two substeps, the first substep comprising using the original model, with all the salt bodies, to downward continue the receiver wavefield from the surface to the Zmax datum, the second substep comprising using the sediment velocity to upward continue the receiver wavefield from the Zmax datum to the Zmin datum; obtaining the wavefield at the Zmin datum as if the velocity in the salt bodies between datum Zmin and Zmax had been replaced with the sediment velocity; and applying Kirchhoff migration algorithms to the data obtained.

3. The method of claim 2, further comprising the step of implementing a fixed constant velocity instead of sediment velocity.

4. The method of claim 2, in the context of azimuth 3D marine acquisition, further comprising the step of deleting intermediate data.

5. The method of claim 2, further comprising the step of moving sources and receivers closer to the subsalt target after redatuming.
